(19) United States
(12) Patent Application Publication
(10) Pub. No.: US 2017/0205914 A1
(43) Pub. Date: Jul. 20, 2017

(54) CLICK-BUTTON-INTEGRATED CONTACT POSITION INPUT APPARATUS

(71) Applicant: ALPS ELECTRIC CO., LTD., Tokyo (JP)

(72) Inventor: Masafumi Takagi, Miyagi-ken (JP)

(21) Appl. No.: 15/405,025

(22) Filed: Jan. 12, 2017

(30) Foreign Application Priority Data
Jan. 18, 2016 (JP) 2016-007244

(51) Int. Cl. G06F 3/044

(52) U.S. Cl. CPC G06F 3/044; G06F 2203/04105

(57) ABSTRACT

An input apparatus has an input device having a manipulation plane manipulated by a finger or another manipulation body and also has a detection element having a movable portion that moves in response to the deformation or motion of the input means. The input apparatus sends output signals received from the input device and detection element. The input means has an input determining portion that determines an input manipulation to the manipulation plane. The detection means has displacement detecting portions that detect the amount of displacement of the movable portion and also has a pressing determining portion that determines a pressing manipulation to the input means according to the amount of displacement. If the input determining portion decides that the manipulation body is in contact with the manipulation plane, the pressing determining portion determines the pressing manipulation.

### CLAIM OF PRIORITY

This application claims benefit of priority to Japanese Patent Application No. 2016-007244 filed on Jan. 18, 2016, which is hereby incorporated by reference in its entirety.

### BACKGROUND

1. Field of the Disclosure

The present disclosure relates to an input apparatus mounted in an electronic device, and more particularly to an input apparatus manipulated by a finger or the like.

2. Description of the Related Art

Recently, input apparatus such as touch pads are frequently used that are mounted in notebook personal computers (PCs) or the like and are manipulated by a finger or the like. In a proposed input apparatus, an input apparatus of this type such as a touch pad is combined with another input device such as push switches or the like so that a variety of inputs can be performed. As the other input device, a load sensor that measures a load has been used in some cases in such a way that the load sensor is attached to the rear surface of an input apparatus (such as a touch pad) so as to be thinned.

In Japanese Unexamined Patent Application Publication No. 2012-18106 (an example of related art), a force sensor 901 in which piezoresistive elements 913 are used is proposed as the above load sensor. FIG. 8 is a schematic plan view of the force sensor 901 in an example of related art when viewed from below.

The force sensor 901 illustrated in FIG. 8 has a silicon substrate 910, on which a pressure receiving portion 912 that receives an external load and a displacement portion 911 that is displaced when it receives a load are mounted, four piezoresistive elements 913 provided in the displacement portion 911 on the silicon substrate 910, electric connecting portions 916, each of which is connected to one of the piezoresistive elements 913, and a flexible substrate 919 that is electrically connected to the electric connecting portions 916. The force sensor 901 is attached to the rear surface of an input apparatus such as a touch pad and detects a pressing manipulation performed by the manipulator (detects a load).

However, there is the possibility that even if an input manipulation is not performed on this type of load sensor (force sensor 901), if a portion in the vicinity of the input apparatus is pressed with a palm or an arm, the load sensor detects a displacement. This has been problematic in that when an actual input manipulation is performed, a malfunction occurs.

### SUMMARY

An input apparatus has an input device having a manipulation plane manipulated by a finger or another manipulation body and also has a detection device having a movable portion configured to move in response to the deformation or motion of the input device. The input apparatus sends output signals received from the input device and a detection element. The input device has an input determining portion configured to determine an input manipulation to the manipulation plane. The detection device has a displacement detecting portions configured to detect the amount of the movable portion and also has a pressing determining portion configured to determine a pressing manipulation to the input device according to the amount of displacement. If the input determining portion decides that the manipulation body is in contact with the manipulation plane, the pressing determining portion determines the pressing manipulation.

Accordingly, if there is no input manipulation to the input device, even if the movable portion of the detection element is deformed or moved, the pressing determining portion does not determine the state of a pressing manipulation. Therefore, even if any force is applied in the vicinity of the input device, no output signal is sent from the detection device. This can reduce malfunctions of the input apparatus.

### BRIEF DESCRIPTION OF THE DRAWINGS

FIG. 1 is a perspective view of an input apparatus in a first embodiment of the present invention, illustrating the structure of the input apparatus;

FIG. 2 is a plan view of the input apparatus in the first embodiment of the present invention when viewed from the Z1 side in FIG. 1, illustrating the structure of the input apparatus;

FIGS. 3A and 3B schematically illustrate the input apparatus in the first embodiment of the present invention, FIG. 3A being a cross-sectional view as taken along line IIIA-IIIA in FIG. 2, FIG. 3B being a cross-sectional view illustrating a state in which the input apparatus in the state in FIG. 3A is pressed downwardly;

FIG. 4 is a block diagram of the input apparatus in the first embodiment of the present invention;

FIG. 5 illustrates the structure of a detection device included in the input apparatus in the first embodiment of the present invention, illustrating the bottom of a movable portion when viewed from the Z2 side in FIG. 1;

FIG. 6 is a drawing to explain the detection device included in the input apparatus in the first embodiment of the present invention, the drawing illustrating a bridge circuit in a pressing determining portion;

FIG. 7 is a flowchart illustrating the operation of the input apparatus in the first embodiment of the present invention; and

FIG. 8 is a schematic plan view of a force sensor in an example of related art when viewed from below.

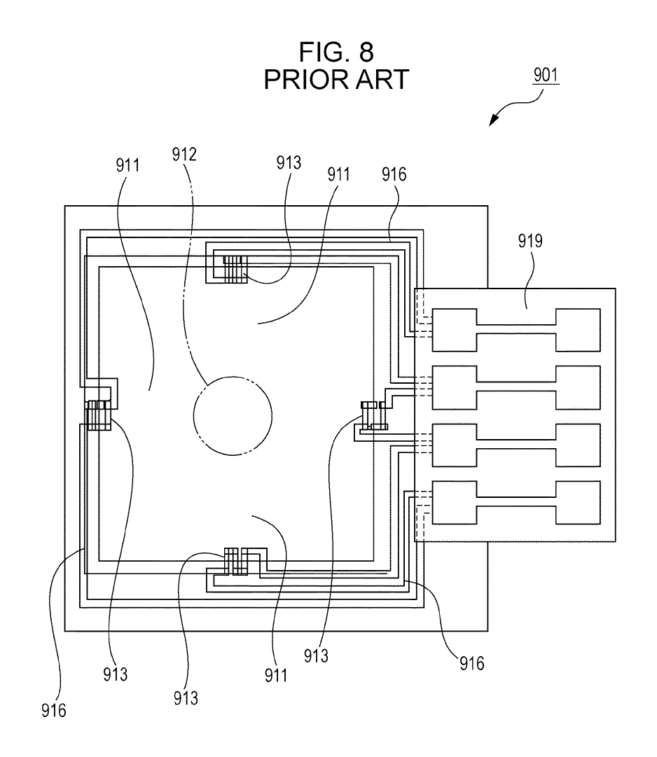

### DESCRIPTION OF THE EXEMPLARY EMBODIMENTS

Embodiments of the present invention will be described below with reference to the drawings.

### First Embodiment

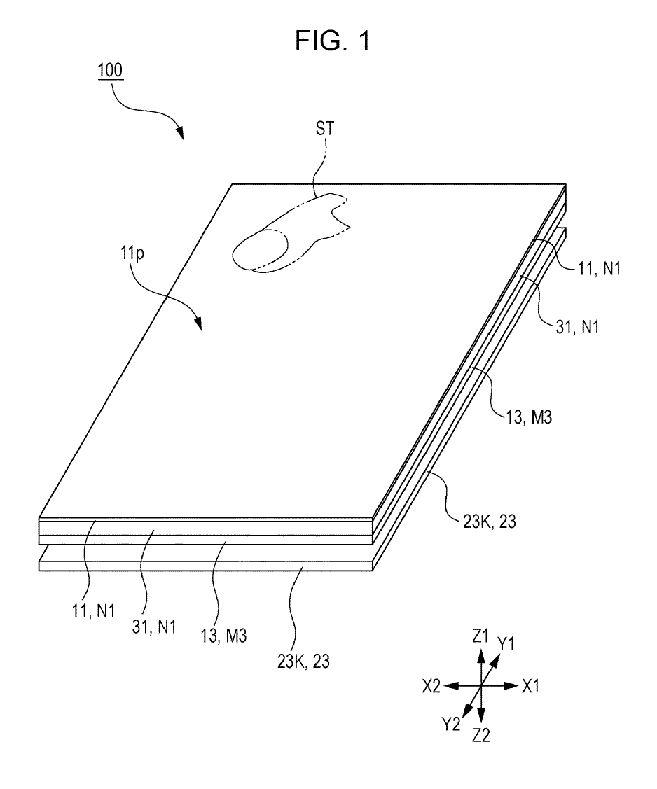

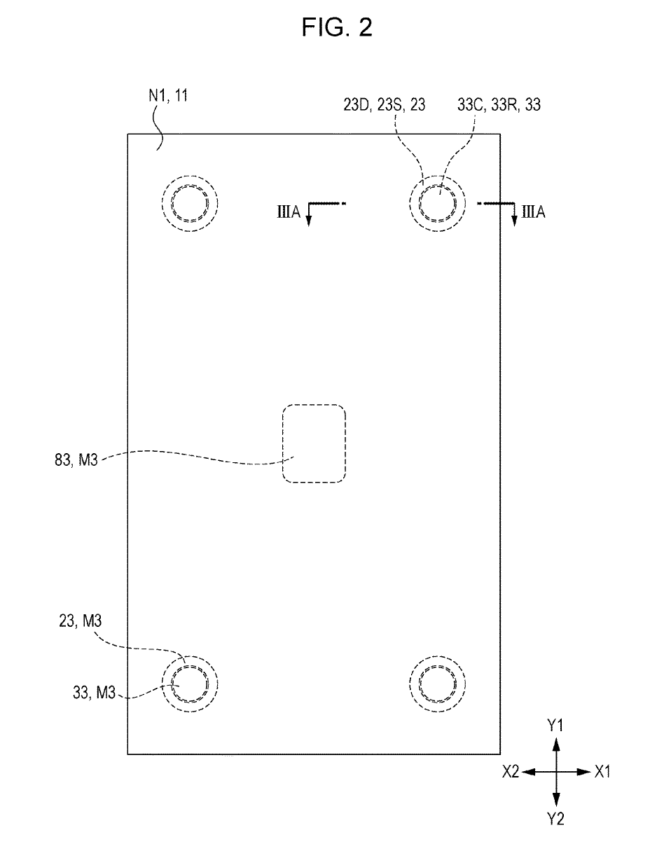

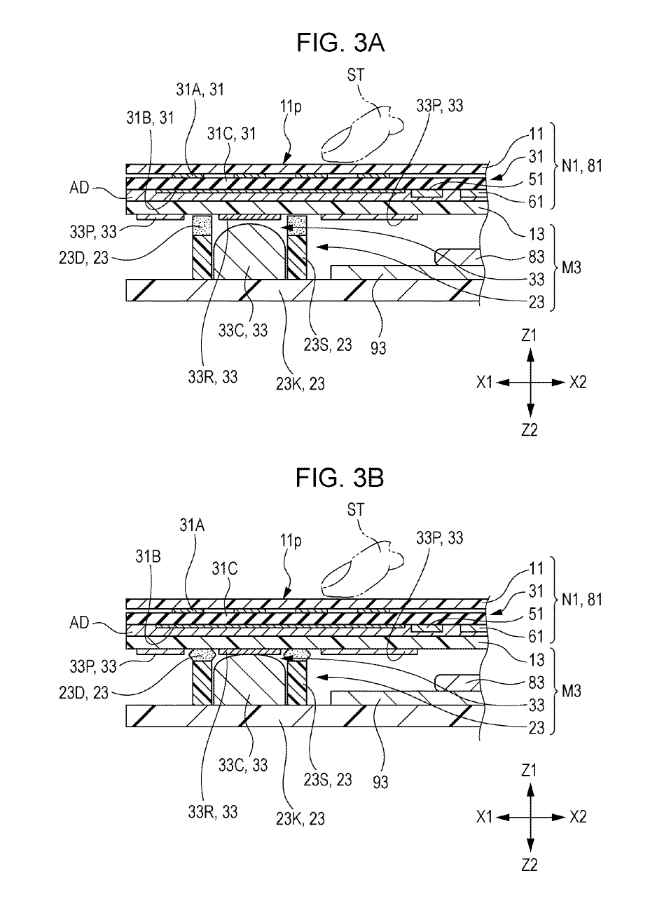

FIG. 1 is a perspective view of an input apparatus 100 in the first embodiment of the present invention. FIG. 2 is a plan view of the input apparatus 100 in the first embodiment of the present invention when viewed from the Z1 side in FIG. 1. FIG. 3A is a schematic cross-sectional view as taken along line IIIA-IIIA in FIG. 2, and FIG. 3B is a schematic cross-sectional view illustrating a state in which the input apparatus 100 in the state in FIG. 3A is pressed downwardly. For easy understanding, in FIG. 2, only part of a support member 23 and only part of a displacement detecting portion 33, which are illustrated in FIGS. 3A and 3B, are indicated by broken lines.

The input apparatus 100 in the first embodiment of the present invention has a rectangular outside shape as illustrated in FIGS. 1 and 2. The main components of the input apparatus 100 are an input device N1 that has a manipulation plane 11p manipulated by a manipulation body ST such as a finger of the manipulator and a detection element M3 for detecting the deformation or motion of the input mean devices N1, as illustrated in FIG. 1 and FIGS. 3A and 3B. The input apparatus 100 is connected to, for example, a notebook personal computer, a vehicle-mounted manipulation device, or another external device. When the manipulator performs an input manipulation to the manipulation plane 11p, the input apparatus 100 outputs input information resulting from the input manipulation and status device information about the deformation or motion of the input device N1, which is caused by the input manipulation, to the external device as output signals from the input device N1 and detection device M3.

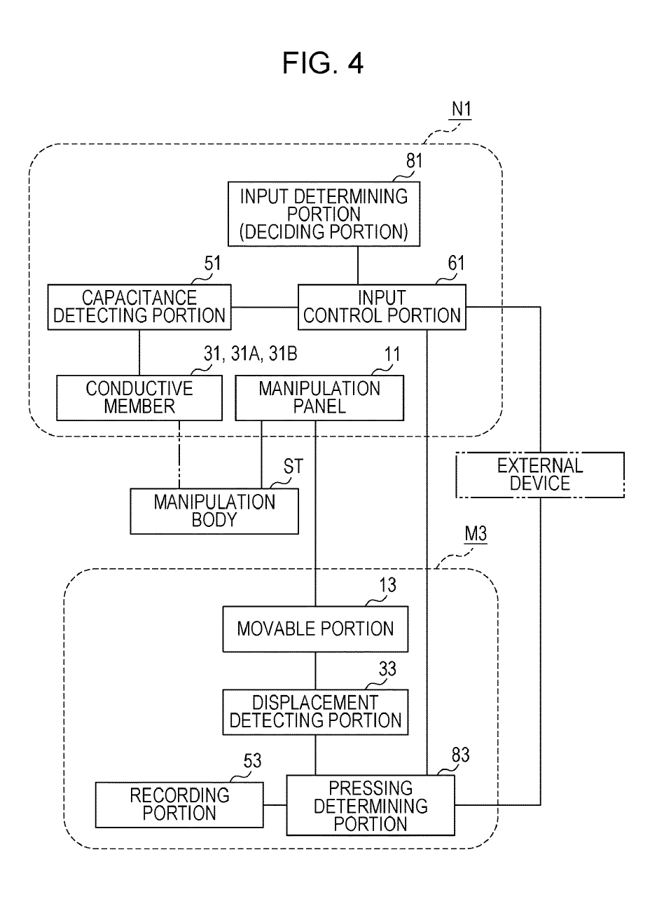

First, the input device N1 of the input apparatus 100 will be described. FIG. 4 is a block diagram of the input apparatus 100 in the first embodiment of the present invention.

The input device N1 of the input apparatus 100 preferably has a manipulation panel 11 including the manipulation plane 11p, a conductive member 31, having a plurality of electrodes, which is disposed on the rear surface of the manipulation panel 11, a capacitance detecting portion 51 that detects a capacitance detected by the electrodes, and an input control portion 61 that outputs a command signal (output signal) corresponding to the input information in response to a signal from the capacitance detecting portion 51, as illustrated in FIGS. 3A and 3B. In the input device Ni, the conductive member 31, capacitance detecting portion 51, and input control portion 61, which are constituent elements of the input m device means N1, are used to form an input determining portion 81 that determines whether the manipulator is performing an input manipulation to the manipulation plane 11p. Input information corresponding to an input manipulation to the manipulation plane 11p can be obtained by the input device N1.

The manipulation panel 11 of the input device N1 is made of a film substrate such as a polyethylene terephthalate (PET) resin. A coating with a color tone suitable to the appearance of the applied external device is formed on the rear surface of the manipulation plane 11p, which is opposite to its front side. The manipulator manipulates the manipulation plane 11p, which is the front surface of the manipulation panel 11, with the manipulation body ST such as a finger. Since a translucent substrate is used as the manipulation panel 11, a display pattern of characters, symbols, artwork, and the like visible to the manipulator may be formed on the rear side of the manipulation plane 11p.

As the conductive member 31 of the input device N1, a so-called double-sided printed wiring board (PWB) is used; wiring patterns made of copper foils are formed on both surfaces of an insulated substrate 31C made of an epoxy resin including a glass filler. As illustrated in FIGS. 3A and 3B, a first detection electrode 31A including a plurality of electrodes is formed on one side of the insulated substrate 31C, and a second detection electrode 31B including a plurality of electrodes is formed on the other side of the insulated substrate 31C. The conductive member 31, disposed on the rear surface of the manipulation panel 11 (on the Z2 side in FIGS. 3A and 3B), has a function that detects a change in capacitance, which is caused by a manipulation of the manipulation body ST. The conductive member 31 and manipulation panel 11 are bonded together by using an adhesive (not illustrated) so as to be unitary.

The capacitance detecting portion 51 of the input device N1 is formed by using an integrated circuit (IC) having a capacitance detection circuit. The capacitance detecting portion 51 is mounted on a PWB, which is used as the conductive member 31, and is electrically connected to a plurality of electrodes of the conductive member 31 (specifically, a plurality of electrodes of the first detection electrode 31A and second detection electrode 31B) (see FIG. 4). In the first embodiment of the present invention, the capacitance detecting portion 51 detects a capacitance generated between the first detection electrode 31A and the second detection electrode 31B.

The input control portion 61 of the input device N1 is formed by using an IC as in the case of the capacitance detecting portion 51. The input control portion 61 is mounted on the PWB used as the conductive member 31, and is electrically connected to the capacitance detecting portion 51 (see FIG. 4). The input control portion 61 outputs a command signal (output signal) corresponding to input information to the external device in response to a signal from the capacitance detecting portion 51. Although, in the first embodiment of the present invention, the capacitance detecting portion 51 and input control portion 61 are formed as different chip elements and are separately packaged, this is not a limitation. For example, the capacitance detecting portion 51 and input control portion 61 may be formed as a single chip element. Alternatively, they may be formed as two chip elements and may be combined into a single package.

The input determining portion 81 of the input device N1 uses the conductive member 31, capacitance detecting portion 51, and input control portion 61, which are constituent elements of the input device N1, and uses an output signal from the input control portion 61, as described above (see FIG. 4). The input determining portion 81 preferably determines the state of the approach of the manipulation body ST that is caused by a manipulation (such as an input manipulation) by the manipulator, according to a change in capacitance obtained from a plurality of electrodes of the first detection electrode 31A and second detection electrode 31B. That is, the input determining portion 81 preferably determines the state of an input manipulation to the manipulation plane 11p; for example, the input determining portion 81 determines whether the manipulator is performing an input manipulation to the manipulation plane 11p.

As described above, in the first embodiment of the present invention, the conductive member 31, capacitance detecting portion 51, and input control portion 61, which are constituent elements of the input device N1, are used to form the input determining portion 81. This enables the input device N1 to be structured so as to be simplified and thinned. A deciding portion (not illustrated in FIGS. 3A and 3B) in the input determining portion 81 may be incorporated into the IC of the input control portion 61 or may be formed separately as another IC.

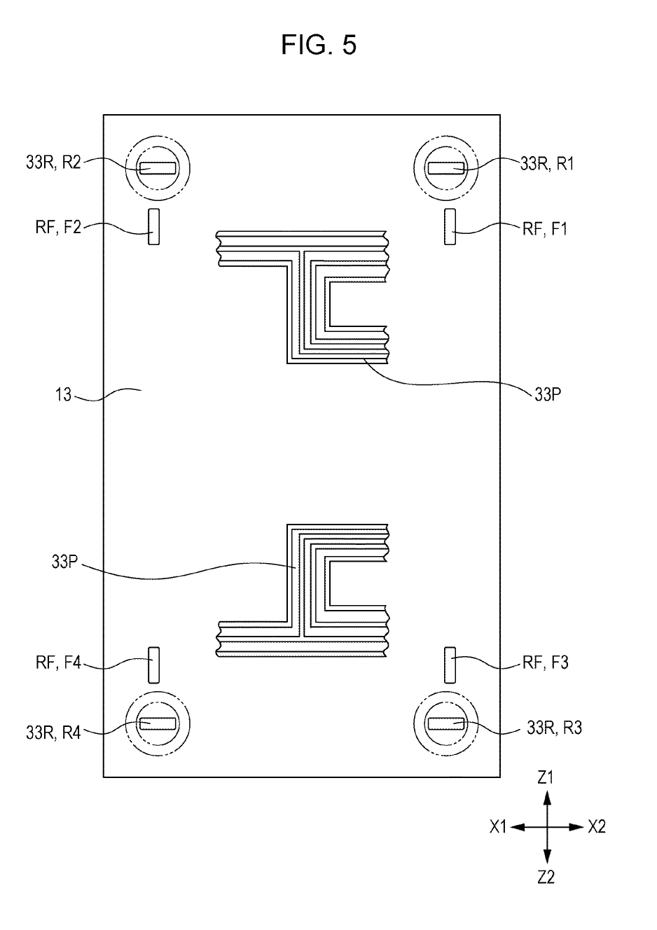

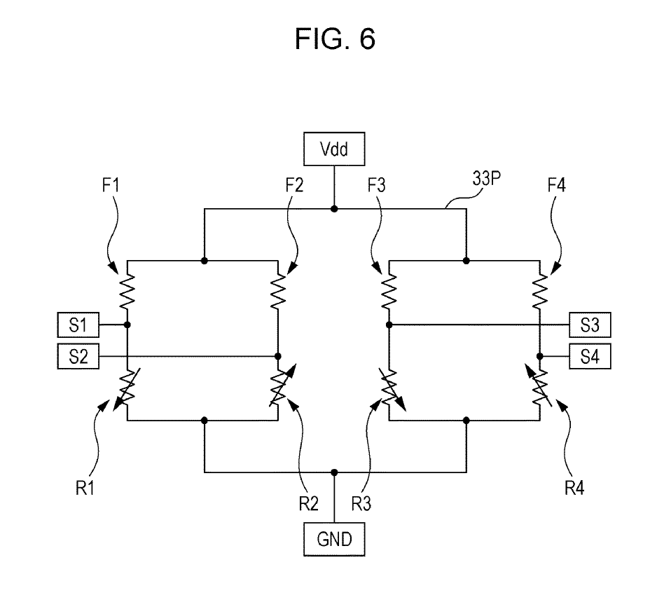

Next, the detection device M3 of the input apparatus 100 will be described. FIG. 5 illustrates the structure of the detection device M3, illustrating the bottom of a movable portion 13 when viewed from the Z2 side in FIG. 1. For easy understanding, part of a wiring part 33P in the displacement detecting portion 33 is omitted. FIG. 6 is a drawing to explain the detection element M3, the drawing illustrating a bridge circuit in the displacement detecting portion 33. In FIG. 6, Vdd indicates a drive, GND indicates ground, and S1, S2, S3, and S4 each indicate an output signal.

As illustrated in FIGS. 3A and 3B, the detection element M3 of the input apparatus 100 has a movable portion 13, on which N1 is mounted, that moves in response to the deformation or motion of the input device N1, displacement detecting portions 33, each of which detects the amount of displacement of the movable portion 13, and a pressing determining portion 83 that determines a pressing manipulation to the input device N1 according to the displacement amount. Although not illustrated in detail, the detection means M3 also has a support member 23 (see FIGS. 3A and 3B) that movably supports the movable portion 13 and a recording portion 53 (see FIG. 4) that stores a reference value according to which a pressing manipulation is determined. Information about the state of the manipulation panel 11 (input device N1) can be obtained by the detection means M3 in response to a pressing manipulation to the manipulation plane 11p.

The movable portion 13 of the detection element M3 uses a film substrate such as a PET resin. As illustrated in FIGS. 3A and 3B, the movable portion 13 is disposed on the lower side of the PWB formed as the conductive member 31 (on the Z2 side in FIGS. 3A and 3B) and is bonded to the second detection electrode 31B of the PWB by using an adhesive layer AD intervening therebetween so as to be unitary. Thus, the movable portion 13 is integrated with the manipulation panel 11 of the input device N1 with the conductive member 31 intervening therebetween (see FIG. 4) and thereby moves in response to the deformation or motion of the input device N1.

The main components of the support member 23 of the detection element M3 are a substrate 23K disposed so as to face the movable portion 13 as illustrated in FIG. 1 and FIGS. 3A and 3B, spacers 23S disposed between the substrate 23K and the movable portion 13 as illustrated in FIGS. 3A and 3B, and elastic bodies 23D, having elasticity, each of which is disposed between the relevant spacer 23S and the movable portion 13 as illustrated in FIGS. 3A and 3B.

The substrate 23K of the support member 23 is made of a synthetic resin such as an acrylonitrile-butadiene-styrene (ABS) copolymer resin. The substrate 23K is formed like a rectangular plate as illustrated in FIG. 1. The case of the external device to which the input apparatus 100 is applied may be used as the substrate 23K.

The spacer 23S of the support member 23 is cylindrically formed by using a synthetic resin such as a polyoxymethylene (POM) resin, as illustrated in FIG. 2; one spacer 23S is disposed at each of the four corners of the substrate 23K (a total of four spacers 23S are disposed).

The elastic body 23D of the support member 23 is cylindrically formed by using an elastic rubber material such as an ethylene propylene rubber. As illustrated in FIGS. 3A and 3B, the elastic body 23D is disposed between the movable portion 13 and the spacer 23S.

When a load is applied to the manipulation panel 11 (input device N1), the elastic body 23D of the support member 23 is deformed by the support member 23 structured as described above, as illustrated in FIG. 3B. This enables the movable portion 13 of the detection element M3 to move.

As illustrated in Figs, 3A and 3B, each displacement detecting portion 33 of the detection element M3 preferably has a resistive member 33R formed on the lower surface of the movable portion 13, a conductive body 33C disposed so as to face the resistive member 33R at a distance from it, and a wiring part 33P that interconnects the resistive member 33R and pressing determining portion 83. In addition, in the movable portion 13, resistive elements RF used for reference purposes are provided on the lower surface of the movable portion 13 (the lower surface is the surface on the lower side on which the resistive members 33R are formed), as illustrated in FIG. 5. The resistive elements RF are included in bridge circuit described later. The displacement detecting portion 33 is structured so that it detects the amount of displacement of the movable portion 13 (see FIG. 4).

The resistive member 33R of the displacement detecting portion 33 has a conductivity with a relatively high resistance. As illustrated in FIG. 5, one resistive member 33R, which is formed as a rectangular pattern, is disposed at each of the four corners of the movable portion 13 (a total of four resistive members 33R, denoted R1, R2, R3, and R4 in FIG. 5, are disposed). Each resistive member 33R is formed at a position at which the spacer 23S and elastic body 23D are disposed and is disposed so as to face the conductive body 33C at a distance from it.

The resistive element RF of the displacement detecting portion 33 has an arbitrary resistance. As illustrated in FIG. 5, one resistive element RF, which is formed as a rectangular pattern, is disposed in the vicinity of each resistive member 33R (a total of four resistive elements RF, denoted F1, F2, F3, and F4 in FIG. 5, are disposed). Although not illustrated in detail, the resistive member 33R and resistive element RF are electrically interconnected with the wiring part 33P. The resistive member 33R and resistive elements RF can be easily manufactured by screen-printing a carbon ink in which carbon powder, an acrylic resin, and a solvent are mixed on the lower surface (rear surface) of the movable portion 13 and drying the ink to cure it.

The conductive body 33C of the displacement detecting portion 33 has a conductivity with a relatively high resistance. As illustrated in FIGS. 3A and 3B, the conductive body 33C is stored in a storage space defined inside the cylindrical spacer 23S and elastic body 23D. Upon the completion of the assembly of the input apparatus 100, the conductive body 33C is disposed so as to face the resistive member 33R at a distance from it. Although, in the first embodiment of the present invention, the conductive body 33C and resistive member 33R are disposed so as to face each other with a space left between them, this is not a limitation. The conductive body 33C and resistive member 33R may be oppositely disposed so as to be in contact with each other.

The conductive body 33C uses an elastic rubber material as a base material. When the movable portion 13 of the detection element M3 is moved downwardly, the conductive body 33C is pressed by the movable portion 13 and is elastically deformed as illustrated in FIG. 3B. At that time, a contact area between the resistive member 33R and the conductive body 33C is increased and a resistance to a current flowing in the resistive member 33R is thereby lowered.

Therefore, the contact area between the conductive body 33C and the resistive member 33R changes in response to the amount of downward displacement of the movable portion 13, and the resistance changes accordingly. That is, a unit formed by a combination of the conductive body 33C and resistive member 33R functions as a variable resistor. This enables the displacement detecting portion 33 to be structured so as to be thinned and simplified. Although, in the first embodiment of the present invention, four units, each of which is a combination of the conductive body 33C and resistive member 33R, are used, this is not a limitation. Preferably, if a plurality of units are used, they are enough.

In the first embodiment of the present invention, two bridge circuits as illustrated in FIG. 6 are formed by using the resistive elements RF, resistive members 33R, conductive bodies 33C, and wiring parts 33P, which constitute the displacement detecting portion 33. Therefore, a plurality of output signals (specifically, four output signals) denoted S1, S2, S3, and S4 are obtained from the two bridge circuits.

The pressing determining portion 83 of the detection element M3 is formed by using an IC as with the capacitance detecting portion 51 and input control portion 61, and is mounted on a wiring board 93 that uses a single-sided PWB as illustrated in FIGS. 3A and 3B. The pressing determining portion 83 is electrically connected to the bridge circuits, formed by using the displacement detecting portions 33, from which output signals generated in a plurality of units (each of which is a combination of the conductive body 33C and resistive member 33R) are obtained, through the wiring board 93 and a flexible printed circuit (FPC), which is not illustrated (see FIG. 4). Thus, the pressing determining portion 83 can preferably determine the amount of displacement caused by the motion of the movable portion 13 by analyzing the four output signals S1, S2, S3, and S4, each of which corresponds to a change in resistance due to a change in the contact area between the conductive body 33C and the resistive member 33R. This enables the detection element M3 to reliably determine the displacement of the movable portion 13 and to reliably determine a pressing manipulation. In addition, since a plurality of units are disposed at arbitrary positions on the movable portion 13, it is possible to detect a variety of motions of the movable portion 13.

The pressing determining portion 83 is electrically connected to the recording portion 53, which stores a reference value according to which the pressing determining portion 83 determines a pressing manipulation. The pressing determining portion 83 outputs, to the external device, status information about the deformation or motion of the input means N1, which is caused by an input manipulation, and pressing information about a pressing manipulation to the input means N1 (see FIG. 4). A generally used internal memory or external memory is preferably used as the recording portion 53.

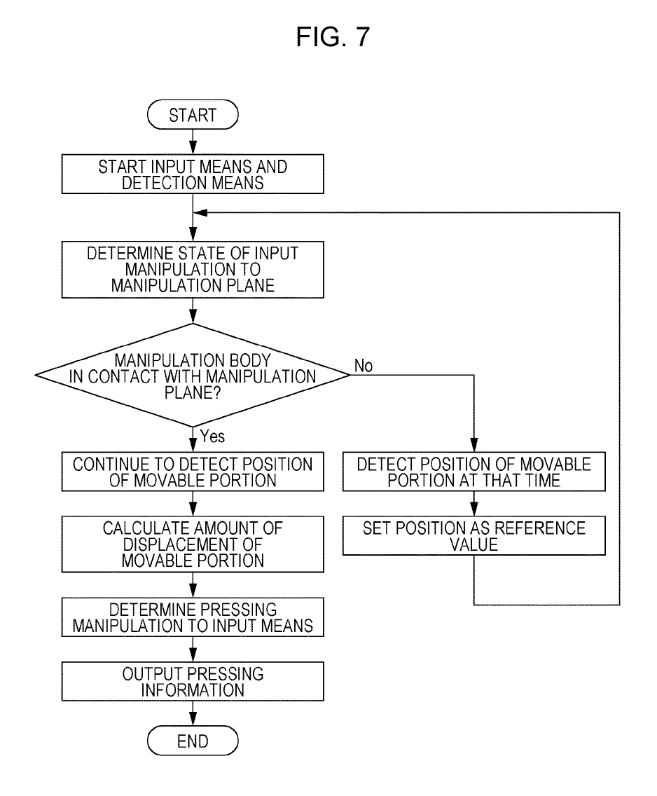

Here, a method of detecting a pressing manipulation to the manipulation plane 11p performed by the manipulator on the input apparatus 100 will be simply described with reference to FIG. 7. FIG. 7 is a flowchart illustrating the operation of the input apparatus 100, specifically a method of detecting a pressing manipulation.

First, the input means N1 and detection means M3 starts.

Next, the input determining portion 81 of the input means N1 decides whether an input manipulation to the manipulation plane 11p by the manipulator is in progress, according to a signal from the capacitance detecting portion 51 (determines an input manipulation). Specifically, the input determining portion 81 decides whether the manipulation body ST of the manipulator is in contact with the manipulation plane 11p.

If the input determining portion 81 decides that the manipulation body ST is not in contact with the manipulation plane 11p, the displacement detecting portions 33 of the detection means M3 preferably detect the position of the movable portion 13 at that time. Specifically, the displacement detecting portions 33 preferably obtain the output values of four output signals S1, S2, S3, and S4 obtained from the two bridge circuits. At the same time, the pressing determining portion 83 preferably stores, in the recording portion 53, the position of the movable portion 13 at that time, which has been detected by the displacement detecting portions 33 (specifically, output values at that time), as a reference value relative to which the amount of displacement of the movable portion 13 is determined. An initial reference value is stored in the recording portion 53 in advance. Each time the most recent reference value is stored, it overwrites and updates the earlier reference value.

If the input determining portion 81 decides that the manipulation body ST is in contact with the manipulation plane 11p, the displacement detecting portion 33 of the detection element M3 continues to detect the position of the movable portion 13. The pressing determining portion 83 calculates the amount of displacement of the movable portion 13 from the reference value (initial value or most recent value). The pressing determining portion 83 determines a pressing manipulation to the input device N1 according to the amount of displacement, and outputs, to the output device, pressing information about the pressing manipulation to the input device N1.

Accordingly, if there is no input manipulation to the input device N1, even if the movable portion 13 of the detection device M3 is deformed or moved, the pressing determining portion 83 does not determine the state of a pressing manipulation. Therefore, even if any force is applied in the vicinity of the input device N1, no output signal is sent from the detection element M3. This can reduce malfunctions of the input apparatus 100.

In the first embodiment of the present invention, the pressing determining portion 83 uses the position detected by the displacement detecting portion 33 as a reference value relative to which the amount of displacement of the movable portion 13 is determined in the calculation of the amount of its displacement. Therefore, even if any force is applied in the vicinity of the input device N1 and the displacement is changed, the displacement changed at that time can be used as the most recent reference value. Accordingly, when a pressing manipulation is performed to the input device N1 subsequently, the pressing determining portion 83 can determine the pressing manipulation according to the amount of displacement from the most recent reference value, enabling the pressing determining portion 83 to reliably determine a pressing manipulation.

As described above, a pressing manipulation performed to the manipulation plane 11p by the manipulator is detected.

Finally, effects of the input apparatus 100 structured as described above in the first embodiment of the present invention will be compiled below.

With the input apparatus 100 in the first embodiment of the present invention, if the input determining portion 81 in the input device N1 decides that the manipulation body ST is in contact with the manipulation plane 11p, the pressing determining portion 83 of the detection means M3 determines a pressing manipulation to the input means N1. Therefore, if there is no input manipulation to the input device N1, even if the movable portion 13 of the detection element M3 is deformed or moved, the pressing determining portion 83 does not determine the state of a pressing manipulation. Accordingly, even if any force is applied in the vicinity of the input device N1, no output signal is sent from the detection element M3. This can reduce malfunctions of the input apparatus 100.

When the pressing determining portion 83 determines the amount of displacement of the movable portion 13, the pressing determining portion 83 uses the position detected by the displacement detecting portion 33 as a reference value relative to which the amount of displacement of the movable portion 13 is determined, so even if any force is applied in the vicinity of the input device N1 and the displacement is changed, the displacement changed at that time can be used as the most recent reference value. Therefore, when a pressing manipulation is performed to the input device N1 subsequently, the pressing determining portion 83 can determine the pressing manipulation according to the amount of displacement from the most recent reference value, enabling the pressing determining portion 83 to reliably determine a pressing manipulation.

The pressing determining portion 83 determines a change in resistance due to a change in the contact area between the conductive body 33C, which is elastically deformed, and the resistive member 33R opposite to it as the amount of displacement of the movable portion 13. This enables the detection element M3 to be structured so as to be thinned and simplified.

Since output signals from a plurality of units (each of which is a combination of the conductive body 33C and resistive member 33R) are output signals from bridge circuits, the pressing determining portion 83 can obtain a plurality of output signals from these bridge circuits. Therefore, the pressing determining portion 83 can determine the amount of displacement of the movable portion 13 from the plurality of output signals, so the displacement of the movable portion 13 can be reliably determined. This enables a pressing manipulation to be reliably determined. In addition, since a plurality of units are disposed at arbitrary positions on the movable portion 13, it is possible to detect a variety of motions of the movable portion 13.

Since the input determining portion 81 determines an input manipulation to the manipulation plane 11 p by the manipulation body ST according to a change in capacitance, the change being obtained from the capacitance detecting portion 51 that detects a capacitance detected by a plurality of electrodes, the input determining portion 81 can easily make this determination. This enables the input device N1 to be structured so as to be thinned and simplified.

The present invention is not limited to the embodiment described above. For example, the present invention can also be practiced by making variations as described below. These variations are also included in the technical range of the present invention.

First Variation

Although, in the first embodiment, the displacement detecting portion 33 has been preferably structured by using units, each of which is a combination of the conductive body 33C and 33R, this is not a limitation. A variable resistance method or a magnetism change detection method may be used to detect a displacement.

Second Variation

Although, in the first embodiment, the displacement detecting portion 33 has been structured by using two bridge circuits, this is not a limitation. The displacement detecting portion 33 may be structured by using only one bridge circuit or three or more bridge circuits. Alternatively, the displacement detecting portion 33 may be structured without using a bridge circuit.

Third Variation

Although, in the first embodiment, a method of detecting a capacitance has been preferably used as a method applied to the input device N1, this is not a limitation. For example, a method of detecting piezoelectricity or a method of detecting a strain may be used instead.

Fourth Variation

Although, in the first embodiment, the first detection electrode 31A and second detection electrode 31 B have been used as a plurality of electrodes, this is not a limitation. Only any one of the first detection electrode 31A and second detection electrode 31B may be used.

The present invention is not limited to the embodiment described above. The present invention can be appropriately modified without departing from the intended scope of the present invention.

What is claimed is:

1. An input apparatus comprising:
an input device having a manipulation plane manipulated by a manipulation body; and
a detection element having a movable portion configured to move in response to a deformation or motion of the input device; wherein
the input apparatus sends an output signal received from the input device and the detection element,
the input device has an input determining portion configured to determine an input manipulation to the manipulation plane,
the detection device has a displacement detecting portion configured to detect an amount of displacement of the movable portion and also has a pressing determining portion configured to determine a pressing manipulation to the input device according to the amount of displacement, and
if the input determining portion decides that the manipulation body is in contact with the manipulation plane, the pressing determining portion determines the pressing manipulation.

2. The input apparatus according to claim 1, wherein if the input determining portion decides that the manipulation body is not in contact with the manipulation plane, the pressing determining portion takes a position detected by the displacement detecting portions when the input determining portion decides that the manipulation body is not in contact with the manipulation plane as a reference value relative to which the amount of displacement is determined.

3. The input apparatus according to claim 1, wherein:
the displacement detecting portion has a conductive body configured to be elastically deformed by being pressed by the movable portion and a resistive member disposed so as to face the conductive body in contact with or at a distance from the conductive body; and
the pressing determining portion determines a change in resistance due to a change in a contact area between the conductive body and the resistive member as the amount of displacement.

4. The input apparatus according to claim 3, further comprising a plurality of units, each of which is a combination of the conductive body and the resistive member; wherein
the pressing determining portion determines the amount of displacement by using an output signal from a plurality of units as an output signal from a bridge circuit.

5. The input apparatus according to claim 1, wherein:
the input device has a manipulation panel including the manipulation plane, a conductive member having a plurality of electrodes, the conductive member being disposed on a rear surface of the manipulation panel, and a capacitance detecting portion configured to detect a capacitance detected by the electrodes; and
the input determining portion determines the input manipulation to the manipulation panel according to a change in the capacitance, the change being caused by a manipulation by the manipulation body.
